(19) United States
(12) Patent Application Publication
(10) Pub. No.: US 2004/0043682 A1
(43) Pub. Date: Mar. 4, 2004

(54) Composite board

(76) Inventors: Steven L. Taylor, Glendora, CA (US); Mark A. Longfellow, Foothill Ranch, CA (US); Norman C. Tracy, Huntington Beach, CA (US); Robert R. Henderson, Tustin, CA (US); Michael Chang, Irvine, CA (US); Roland S. Weber JR., Rancho Palos Verdes, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/236,053

(22) Filed: Sep. 4, 2002

(51) Int. Cl. B32B 27/12; B32B 13/02; B32B 13/14; B32B 5/02; B32B 27/04

(52) U.S. Cl. 442/42; 442/43; 442/45; 442/49

(57) ABSTRACT

A composite board for use as backerboard for tile, the board including a mesh layer with a mesh fabric, a mat layer with a mat fabric and a polystyrene layer disposed between the two portions where a non-shrinking cement compound saturates and connects the two outer portions with the polystyrene substrate. The composite board's mesh layer incorporates a stretchable mesh which in conjunction with the polystyrene substrate and the non-shrinking cement compound supports standard fasteners used in the home-building industry along with providing a suitable tile adhesion surface. The mat layer incorporates a fiberglass mat which provides high rigidity as well as being suitable for contact with an inner wall or studs. The combination of materials provides a backerboard that is light weight, rigid, economical and easy to build with.

### BACKGROUND OF THE INVENTION

This invention generally relates to a structural panel suitable for use in construction of walls, floors, countertops, and the like, particularly where high moisture conditions are encountered, such as in a shower enclosure or bathtub wall. More particularly, the invention relates to an improved composite board made of a planar core of expanded polystyrene, and outer reinforcement layers including a reinforcement fabric and a cement compound.

Ordinary gypsum based panels such as those used in dry wall construction commonly are not sufficiently resistant to moisture to permit successful use of such gypsum based panels in places such as a shower enclosure or bathtub wall. Ceramic tile mounted upon such gypsum panels, even though well grouted, will in a short time typically come loose, and the gypsum panels will disintegrate, due to penetration of moisture. Where the substrate for a tile overlay comprises ordinary gypsum plaster, the moisture from the tub or shower will be absorbed by the gypsum plaster which will disintegrate, causing the gypsum plaster to weaken, and permitting the tiles to come loose. Because of these difficulties due to moisture in bathrooms, shower areas, kitchens or other areas where water is present, at least at times, it has been necessary in constructing such walls, floors, countertops and the like, to use a concrete base or other special treatment.

Prior attempts at making a suitable tile backerboard generally include cementitious backerboards, composite fiber cement boards, coated gypsum based boards, hybrid based boards, and extruded foam boards. Conventional cementitious backerboards are typically sturdy and water resistant, but are also typically heavy, brittle and hard to work with. Conventional composite fiber cement boards are generally sturdy, clean cutting, and water resistant, but are also typically heavy, difficult to cut, and difficult to nail.

Gypsum based boards such as water resistant gypsum panels commonly known as “greenboard” are generally inexpensive and easy to work with, but can also be susceptible to water damage. Hybrid based boards are generally economical and easy to install but are also heavy, and gypsum based. Extruded foam boards are generally light, rigid and sturdy, but are expensive. In addition, special fasteners are generally required to mount the board, and the board must be scored on both sides to be broken.

Accordingly, there is a long-standing need to provide a backerboard that is lightweight, rigid, economical and easy to install with common fasteners. The present invention satisfies these and other needs.

### SUMMARY OF THE INVENTION

The present invention provides a composite board suitable for use as a tile backerboard. The composite board generally includes a middle planar polystyrene layer or core, and first and second outer reinforced cement portions on the planar sides of the polystyrene layer. As a tile backerboard the composite construction provides a backerboard that is lightweight, rigid, economical and easy to install.

In one implementation, the composite board is formed as a three-part composite board for use as a tile backerboard. For clarity purposes the composite board may be referred to as including top, bottom, and center portions. In practice, the top and bottom portions may be interchanged. In one aspect, a planar center portion or core is formed from polystyrene, such as expanded polystyrene, for example. In another aspect, the top portion may be formed from a combination of a mesh fabric such as a woven polypropylene fabric, and a non-shrinking cement compound. In this configuration the cement compound may be saturated into the mesh fabric. The center portion is bonded to the top portion with the non-shrinking cement compound of the top portion. A bottom portion may be formed from a combination of a fiberglass mat fabric with an alkali resistant coating, such as an acrylic coating, for example, and a non-shrinking cement compound. In this configuration the cement compound also may be saturated into the mat fabric. The bottom portion may be bonded to the center portion with the cement compound. In an alternate embodiment, the bottom portion may also be formed from a combination of a mesh fabric such as a woven polypropylene fabric, and a non-shrinking cement compound.

The top portion may be configured in a woven mesh layer with a combination of a cement compound and a grid-like woven polypropylene mesh. The grid-like mesh pattern may be composed of a series of small square openings of which a conventional building nail or screw can fit within. The grid-like pattern when combined with the cement compound provides a sound substrate surface for applying mortar. The grid-like pattern of the mesh layer helps retain the mortar and therefore tiles mounted to the top portion as well.

The center portion may be configured in a layer of expanded polystyrene, which is relatively inexpensive, and which may be fused to be waterproof. The polystyrene layer may be cut from a molded expanded polystyrene billet, or may be individually molded.

The bottom portion may be configured in a mat layer with a combination of a relatively inexpensive mat incorporating non-woven or woven fiberglass fibers and a cement compound. When combined with the cement compound the mat becomes relatively rigid, smooth and easily conformable to a flat mounting surface on which the composite board may be mounted.

In practice the composite board is lightweight, rigid, economical and easy to install because of its unique composite construction. The low weight is partly due to the board's expanded polystyrene layer while the rigidity is provided by the reinforced cement layers joined to the polystyrene layer. The composite board is also economical because of the low cost expanded polystyrene center section and the use of a mesh fabric on only one surface of the board.

The composite board is easily sized because only the mesh portion must be scored to break the board and may be easily attached to a supportable wall due to its relatively small grid-like mesh pattern that accepts conventional fasteners. The design of the board may also simplify the layout for the holes for plumbing fixtures in walls by allowing the board to be set in place and pressed against the wall and protruding plumbing fixtures. The plumbing layout marks can be essentially embossed into the mat layer of the panel.

Other features and advantages of the invention will become apparent from the following detailed description, taken in conjunction with the drawings, which illustrate, by way of example, the features of the invention.

### BRIEF DESCRIPTION OF THE DRAWINGS

FIG. 1 is a perspective exploded view of a composite board according to the invention.

FIG. 2 is a side view of the composite board according to the invention.

FIG. 3 is a side view of the mesh portion of a composite board according to the invention.

FIG. 4 is a side view of the mat portion of a composite board according to the invention.

FIG. 5 is a perspective view of a composite board according to the invention fastened to a wooden substrate.

FIG. 6 is a cross-sectional view of the composite board taken along lines 6-6 of FIG. 5.

FIGS. 7A and 7B are elevational diagrammatic views of a board manufacturing apparatus according to the invention, FIG. 7B differing somewhat in scale from FIG. 7A for clarity.

### DETAILED DESCRIPTION OF THE PREFERRED EMBODIMENTS

The present invention is directed to a composite board that is lightweight, rigid, economical and easy to install. In the following embodiment, the board is configured to be used as a tile backerboard.

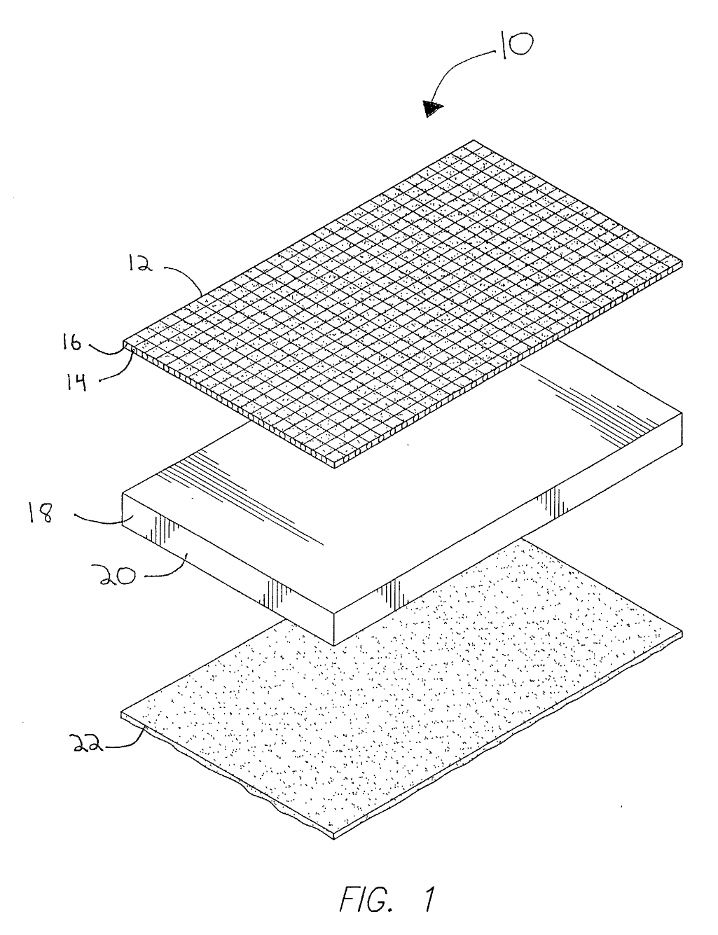

An exploded view of a composite tile backerboard 10 is shown in FIG. 1 incorporating essentially three portions. As shown, a first outer or top portion 12 includes a combination of a woven mesh fabric 14 and a cement compound 16 to form a mesh fabric layer, a planar center portion or core 18 includes an expanded polystyrene 20 to form a polystyrene layer and a second outer or bottom portion 22 includes a combination of a mat fabric 24 and a cement compound 16 to form a mat layer (shown in FIG. 4). In an alternate embodiment, the bottom portion may be also formed of the woven mesh fabric and cement compound. For clarity purposes, the composite board is referred to as including top, bottom and center portions while in practice the top and bottom portions may be interchanged.

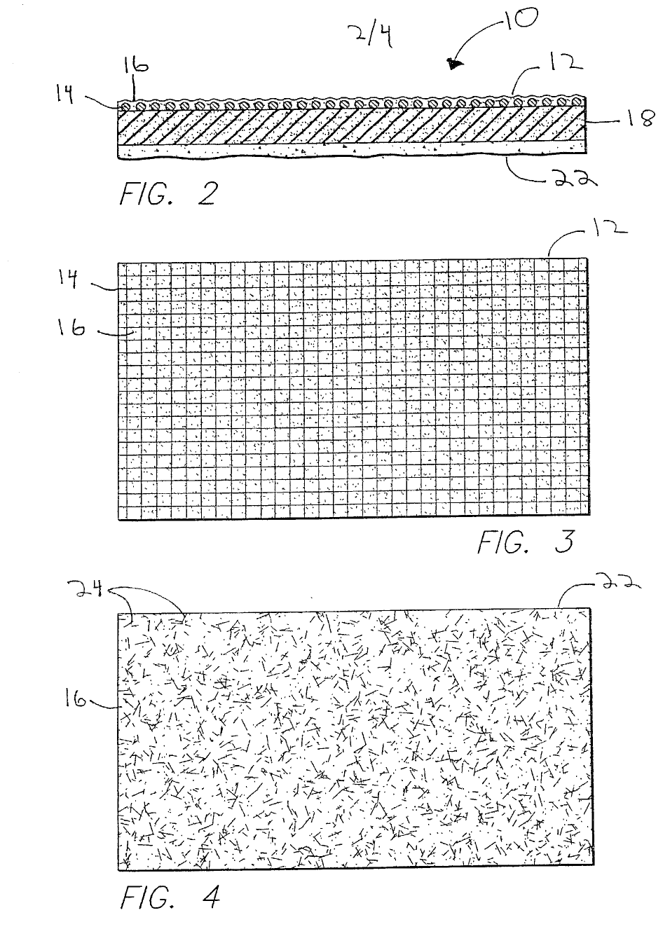

The three layers of the composite board 10 including the mesh layer 12, polystyrene layer 18 and mat layer 22 as shown in a side view of the board in FIG. 2. The mesh layer is approximately 1 mm thick, the polystyrene layer is approximately 9 mm thick and the mat layer is approximately 1 mm thick. The thicknesses of each layer can vary to give the board a total width of approximately 6 to 14 mm. The board is also usually configured with a width of approximately 3 to 4 feet and a length of approximately 4 to 12 feet. In its complete form, the board weighs approximately 0.5 to 1.0 pounds per square foot.

The mesh layer 12 as shown in FIG. 3 includes a combination of a woven mesh fabric 14, such as a woven mesh fabric of polypropylene, for example, and a non-shrinking cement compound 16. The mesh fabric has a grid-like pattern with square openings 28 of about 0.25 inch by 0.25 inch of which the sizes can be reduced to 0.0625 inch by 0.0625 inch depending on design requirements. The relatively small 0.25 inch openings in this preferred embodiment are well suited to standard housing fasteners such as nails or screws and do not necessitate the use of washers because at least three strands of mesh are likely to be captured by a common fastener. The grid-like pattern also helps retain mortar which may be applied to affix tiles in a vertical fashion to the board with a strong mechanical bond. The non-shrinking cement compound is saturated into the mesh fabric, providing rigidity, a solid surface to adhere mortar to and a non-shrinking property to the mesh layer. The mesh fabric is coated with enough cement compound slurry to adhere it to the polystyrene layer 18 and yet still leave a textured surface. This texturing has more surface area than a smooth surface, or one with wider mesh spacing. With greater surface area to bond to, there is greater bond strength between the tile and the backerboard 10. In addition, the rough surface creates a mechanical bond between the adhesive and the board. The combination of the mesh fabric and the cement compound that make up the mesh layer is approximately 1 mm thick.

The polypropylene mesh 14 also has many inherent features such as elasticity, resistance to cement alkalinity, low cost and large diameter strands which make a desirable texture. The elasticity of the mesh is such that the strands will elongate when under the forces of a fastener or impact of a hammer. This allows the mesh to stretch as the fastener is driven into the panel and not break. In another form, the mesh may be non-alkali resistant and thereafter coated with an alkali resistant coating to be compatible with the cement compound.

The non-woven mat layer 22 shown in FIG. 4 includes a combination of a non-woven mat fabric 24 such as fiberglass, for example, with an alkali resistant coating, such as an acrylic coating, for example, and a non-shrinking cement compound 16. In an alternate aspect, the fiberglass mat fabric may be woven. The mat fabric typically incorporates interwoven fiberglass fibers, while the acrylic coating prevents the mat from being detrimentally affected by the alkalinity of the non-shrinking cement compound. With its relatively smooth surface, the mat portion is well suited to be fitted up against a flat surface such as a stud. The mat is also economical, being less expensive than a similarly sized mesh fabric. In addition, the fibers tend to stretch less than mesh weaves. This provides the board with a strong resistance to bending when the mat side is abutted to a series of studs where the most common force on a wall is a pressing between the studs. The mat layer has the greatest accumulation of tensile stresses as the tile wall is leaned against or pressed, therefore the reinforcement requirements on this surface are different than those on the tile surface. The random nature of the fiber distribution in the mat fabric, along with the low elasticity of fiberglass provides strength in almost every direction in the X-Y plane. The combination of the mat fabric and the cement compound that make up the mat layer is approximately 1 mm thick.

The cement compound slurry 16 adheres the fabric to the expanded polystyrene core 18, provides a cementitous surface for tile bonding mortars to adhere to, and provides compressive strength which helps to stiffen the board 10. Non-shrink additives may be added to the cement compound slurry to minimize the shrinking of the slurry on the board as it is cured. Shrinkage of the slurry during the curing process may cause the panels to warp and become non-flat. Polymers may also be added to the cement compound slurry to increase the adhesion between the slurry and the mesh and mat fabrics.

In a presently preferred aspect, the non-shrinking cement compound includes approximately 20-35% by weight Portland cement, approximately 20-35% by weight calcium aluminate cement, approximately 10-40% by weight silica sand, approximately 2-6% by weight vinyl acetate-ethylene (VAE) copolymer, approximately 0-0.25% cellulose ether, approximately 0.5 to 1% by weight of a surfactant, and approximately 10-20% gypsum. Other commercially available types of non-shrinking cement may also be suitable.

In general, the expanded polystyrene 20 of the polystyrene layer 18 has a lower modulus of elasticity than extruded polystyrene. Using the mesh/mat combination as a reinforcement helps to stiffen the polystyrene layer. The polystyrene layer is commonly available in block molded, expanded polystyrene where large blocks of expanded polystyrene are formed and then sliced into thin cores. The density of the polystyrene is approximately 1.0 to 4.0 lb/ft³ with the layer being approximately 9 mm thick. In conjunction with the mat layer 22, the polystyrene layer enables a builder to easily score the composite to size, needing only to score the mat side of the board. In addition to providing structural support for the composite board and to providing matting surfaces on both sides of the board, the non-shrinking cement compound 16 adheres the mesh layer 12 and the mat layer to the polystyrene layer. The non-shrinking properties of the cement compound enable the composite board to remain flat after the mesh layer and mat layer have adhered to the polystyrene layer and after drying. At the present time, this is one of the most economical ways to produce expanded polystyrene cores. The invention can also incorporate other forms of expanded polystyrene such as individually molded planks if economies of scale warrant the use of this technology.

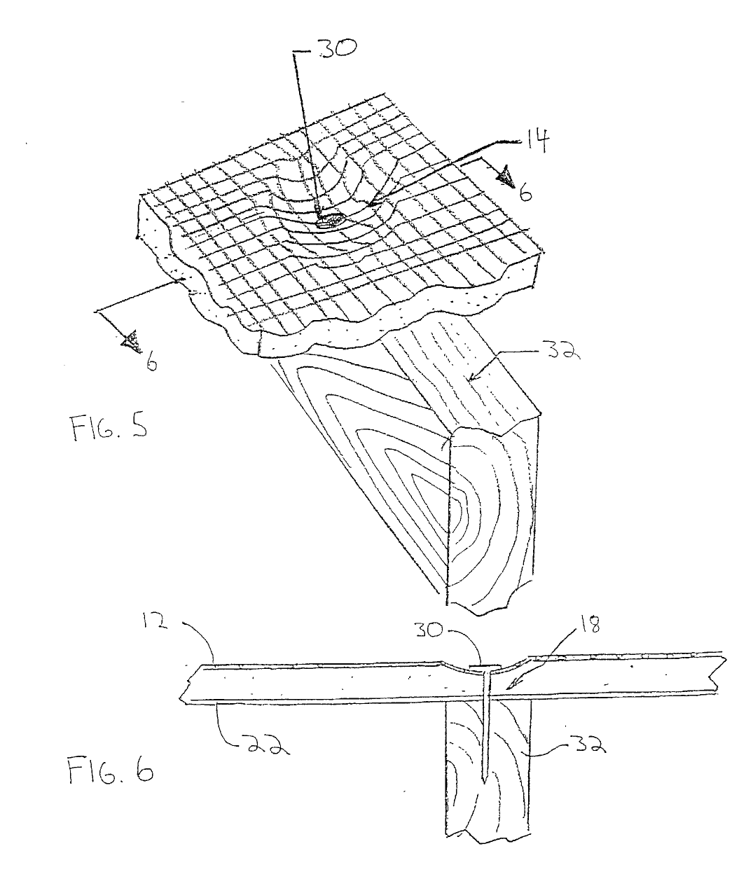

The composite board 10 is shown fastened to a wooden substrate 32 in FIG. 5. A fastener 30 in the form of a roofing nail secures the composite board to a wooden substrate. The mesh fabric 14 is elongated due to the force of a hammer impacting the fastener. As shown in FIG. 6, the fastener compresses the polystyrene layer 18 along with elongating the mesh fabric. The respective compression and elongation helps to retain the fastener. Neither the polystyrene nor the mesh is detrimentally affected by the distortion, rather both are suitably flexible for the respective compression and elongation. The mat layer 22 remains substantially flat in abutting the wooden substrate.

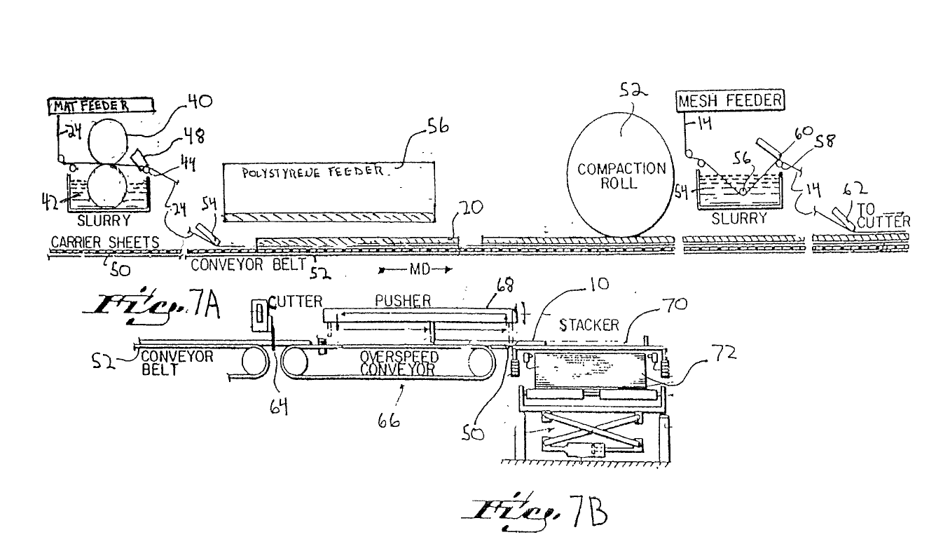

FIGS. 7A and 7B diagrammatically illustrate the features of a composite board manufacturing process. Considering FIGS. 7A and 7B, it will be seen that a continuous web of approximately three feet wide continuous length mat fabric 24 is fed through a roll coater 40 wherein the slurry material 42 therein constitutes a hydraulic cement mixture. As shown in FIG. 7A, the mat fabric is drawn through the roll coater by virtue of a roller 44 such that the hydraulic cement is applied to both sides of the mat fabric. Thereafter, the mat fabric is pulled from the roll coater and any excessive slurry is doctored from the mat by virtue of an adjustable doctoring blade or metering apparatus 48, which can be adjusted to control the amount of slurry actually applied to the mat.

From the metering apparatus 48, the mat fabric then travels downwardly to a point where it is laid onto a plurality of oiled carrier sheets 50. Each of the carrier sheets is supported and conveyed by a conveyor belt 52 with the sheets in abutting relationship so that a forward end of each carrier sheet preferably contacts the trailing end of a preceding carrier sheet. While it may be possible to lay the slurried mat fabric onto carrier sheets which are spaced apart, it is preferable to lay the carrier sheets end to end in abutting relationship as described in order to maintain uniformity of the board face. The carrier sheets can be placed on the conveyor belt upstream of the slurry bath by any appropriate means, which do not constitute part of this invention.

Continuing now with the description of the method by which the board 10 is formed, the slurried mat fabric is laid down on the carrier sheets by virtue of a drag bar 54, which is positioned above the mat fabric and which drags against its upper surface, thereby serving to urge hydraulic cement on the upper surface of the mat fabric into the interstices of the mat fabric and through the mat fabric. It should be appreciated, however, that the drag bar does not remove or scrape from the mesh all of the hydraulic cement, but rather leaves a quantity of cement compound on the upper surface of the mat fabric.

Proceeding from the drag bar 54, the conveyed carrier sheets and mat fabric move beneath the polystyrene feeder 56. The polystyrene feeder transfers the polystyrene cores 20 which are approximately three feet wide onto the slurried mat fabric.

Thereafter, the conveyor belt moves the abutting carrier sheets 50, the mat layer 22 and the polystyrene core into a compaction station formed by compaction roll 52, which serves to compact the polystyrene core against the mat layer. This enhances the bond of the slurried mesh to the relatively crumbly core.

Thereafter, an approximately three foot wide continuous length mesh fabric 14 is fed through a slurry bath or trough 54 containing a slurry, also of the hydraulic cement-mixture previously described. The mesh fabric is drawn through the bath 54 by virtue of the roller 56, and thereafter past roller 58 and a second adjustable doctor blade or metering apparatus 60 for controlling the amount of slurry applied to the mesh fabric. Both metering apparatus 48 and 60, and the roll coater and slurry bath can be of any suitable form. The slurry metering can be accomplished in any suitable fashion.

From the metering apparatus 60, the mesh fabric 14 is conveyed onto the upper surface of the compacted polystyrene core 20 by virtue of a second drag bar 62 at which point the mesh is laid down on top of the polystyrene core. The drag bar is operable to urge the hydraulic cement on the mesh fabric into the interstices thereof and through the mesh, so that a sufficient amount of hydraulic cement resides on lower surface of the mesh fabric and thereby contacts the surface of the polystyrene core for bonding thereto. Subsequent stacking for curing serves to enhance the bond.

From the drag bar 62, the composite board 10, including a slurried lower mat layer 22, a polystyrene layer 18 and a slurried upper mesh layer 12, is conveyed into a cutter station as depicted in FIG. 7B. This illustration, for clarity, shows the formed panel web in lesser detail than in FIG. 7A.

The cutter station includes a cutter 64 for moving transversely across the formed composite board and cutting the board between adjacent and abutting carrier sheets to approximately three feet in length. The details of the cutter will be hereinafter described.

From the cutter 64, the now individual composite board 10, and its respective carrier sheet 50, is conveyed onto an overspeed conveyor 66 operating at a speed in excess of that of conveyor 52, to separate a cut board and carrier sheet from the integral semi-continuous formed board upstream of the cutter. Once the now cut board and associated carrier sheet is moved onto the overspeed conveyor, it is sensed, as will be described, and is pushed from the overspeed conveyor, via pusher 68, onto the stacking apparatus 70. Stacker serves to form a stack 72 of assemblies, each of which comprise a carrier sheet with a composite board 10 thereon. When a full stack is formed, the stack is conveyed away from the stacking apparatus for further curing and storing. Once cured, the boards are ready for use in many construction and remodeling applications. As will be appreciated, various panel face texturizing means could be provided to texturize the hydraulic cement on the panel face to any desired design. In addition, the edges of the composite boards are preferably painted with the slurry cement to provide the finished panel with the appearance of having a cementitious core like traditional cementitious backerboards, and to help to seal the edges of the finished panels from moisture.

Having now described the invention in detail, further advantages and modifications which can be made without departing from the scope of the invention will be appreciated by those of ordinary skill in the art, and the applicant intends to be bound only by the claims appended hereto.

What is claimed:

1. A composite board, comprising:
an expanded polystyrene planar core having top and bottom planar sides; and
first and second outer reinforcement portions bonded to said top and bottom planar sides of said expanded polystyrene planar core, at least one of said first and second outer reinforcement portions including a woven mesh fabric and a cement compound.

2. The composite board of claim 1, wherein the woven mesh fabric comprises a polypropylene mesh fabric.

3. The composite board of claim 2, wherein the cement compound is non-shrinking.

4. The composite board of claim 1, wherein the woven mesh fabric is saturated with the cement compound.

5. The composite board of claim 1, wherein the woven mesh fabric is formed in a grid-like pattern.

6. The composite board of claim 3, wherein one of the first and second outer reinforcement portions comprises a fiberglass mat fabric with an alkali coating and a non-shrinking cement compound.

7. The composite board of claim 1, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

8. A composite board, comprising:
an expanded polystyrene planar core having top and bottom planar sides; and
first and second outer reinforcement portions bonded to said top and bottom planar sides of said expanded polystyrene planar core, at least one of said first and second outer reinforcement portions including a non-woven mat fabric and a cement compound.

9. The composite board of claim 8, wherein the non-woven mat fabric is comprised of a fiberglass mat fabric with an alkali coating.

10. The composite board of claim 9, wherein the cement compound is non-shrinking.

11. The composite board of claim 8, wherein the non-woven mat fabric is saturated with the cement compound.

12. The composite board of claim 10, wherein one of the first and second outer reinforcement portions comprises a polypropylene mesh fabric and a non-shrinking cement compound.

13. The composite board of claim 12, wherein the polypropylene mesh fabric is saturated with the non-shrinking cement compound.

14. The composite board of claim 13, wherein the polypropylene mesh fabric is formed in a grid-like pattern.

15. The composite board of claim 8, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

16. A composite board comprising:
a mesh portion;
a mat portion; and
a polystyrene portion disposed between the mesh portion and mat portion.

17. The composite board of claim 16, wherein the mesh portion is comprised of a polypropylene mesh fabric and a cement compound.

18. The composite board of claim 17, wherein the cement compound is non-shrinking.

19. The composite board of claim 18, wherein the polypropylene mesh fabric is saturated with the non-shrinking cement compound.

20. The composite board of claim 19, wherein the polypropylene mesh fabric is formed in a grid-like pattern.

21. The composite board of claim 16, wherein the mat portion is comprised of a fiberglass mat fabric with an acrylic coating and a cement compound.

22. The composite board of claim 21, wherein the cement compound is non-shrinking.

23. The composite board of claim 22, wherein the fiberglass fabric with an acrylic coating is saturated with the non-shrinking cement compound.

24. The composite board of claim 16, wherein the polystyrene portion is comprised of an expanded polystyrene.

25. The composite board of claim 17, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

26. The composite board of claim 21, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

27. A three-portioned composite board for use as a tile backerboard, the composite board comprising:
a mesh layer comprised of a polypropylene mesh fabric saturated with a non-shrinking cement compound;
a mat layer comprised of a fiberglass mat fabric with an acrylic coating saturated with a non-shrinking cement compound; and
a polystyrene layer comprised of an expanded polystyrene disposed between the mesh layer and the mat layer.

28. The composite board of claim 27, wherein the board has a length of approximately 4 to 12 feet, a width of approximately 3 to 4 feet and a thickness of approximately 6 to 14 mm.

29. The composite board of claim 27, wherein the board weighs approximately 0.5 to 1.0 pounds per square foot.
